(19) United States
(12) Patent Application Publication
(10) Pub. No.: US 2016/0243565 A1
(43) Pub. Date: Aug. 25, 2016

(54) Apparatus Adding a Non-liquid Additive to a Shower Stream

(71) Applicant: Barbara Batista, Lake Suzy, FL (US)

(72) Inventor: Barbara Batista, Lake Suzy, FL (US)

(21) Appl. No.: 14/814,255

(22) Filed: Jul. 30, 2015

Related U.S. Application Data
(60) Provisional application No. 62/176,600, filed on Feb. 24, 2015.

(51) Int. Cl. B05B 7/00; B05B 1/18

(52) U.S. Cl. CPC B05B 7/00; B05B 1/18

(57) ABSTRACT

An apparatus adding a non-liquid additive to a shower stream exited from a showerhead including a perforated container, an elongated arm attached to the container, and a fitting affixed to the elongated arm to provide a fixed position of the elongated arm relative to the showerhead. The fitting is configured for mounting the elongated arm to a shower structure, such as a shower supply pipe, or a wall to define a position of the container relative to a shower stream. And the container, being positioned at least a part in a shower stream, stores, infuses and dispenses a non-liquid additive.

### CROSS REFERENCE TO RELATED APPLICATIONS

This application claims the benefit under 35 USC 119 of U.S. Provisional Application Ser. No. 62/176,600, filed on Feb. 24, 2015, entitled Shower Spa, which is incorporated herein by reference in its entirety.

### BACKGROUND

1. Field of the Technology

The disclosure relates to the fields of shower accessory, mixing, dissolving, or entraining additives in a shower stream prior to discharge. U.S. CI.: 239/310, 239/10

2. Background of the Invention

The art of dispensing an additive or soap into shower water is well known. The previously known devices provide various methods to solve the problem of dispensing an additive or soap without creating counter-pressure to a shower stream. These methods can be divided into two categories.

A first method teaches a means for adding or mixing an additive or soap into shower water before it is emitted from a showerhead. For instance, U.S. Patent Application Publication No. 2009/0,101,733 discloses a device dissolving water-soluble additives in a mixing chamber integrated into a showerhead. Even though using the pressure of water supplied to the showerhead solved the problem of counter-pressure, to use the device it is required to change the showerhead. Such an installation is time consuming and difficult. It also did not allow its user to carry or install it easily when necessary, e.g. in hotels or motels.

A second method discloses liquid additive dispensing devices in which the additive is added to shower water after the water exits the showerhead. U.S. Pat. Nos. 8,028,933 and 6,923,384 provide such devices dispensing liquid additives to shower water exiting from a showerhead using a removable body member mounted to a receptacle or a hanging additive reservoir with a valve. The devices provide a small amount or droplets of a liquid additive with only a small portion of the devices, such as a valve, merged into the shower stream. However, because it is merely merged into a shower stream, the devices are not usable with non-liquid additives.

Limiting the nature of the workable additive prohibits users from obtaining benefit of various minerals, such as catechins from a green tea, which are antioxidants that fight and may even prevent cell damage, while taking a shower. Also, there is a need to provide devices for which installation is easy, not time-consuming and that is simple and inexpensive.

U.S. Patent Application Publication No. 2009/0,101,733 describes a controlled dispensing hand-held shower to dissolve water soluble into shower water. The apparatus is configured with a mixing chamber in the nozzle of a showerhead, which holds water soluble and mixes it with a shower water before the water exits a showerhead.

U.S. Pat. No. 8,028,933 describes an apparatus dispensing shower additive. The apparatus is constituted of an arm, a receptacle mounted to the arm, a body member, which has a cavity to retain a fluid and removably mounted on the receptacle, and microporous flow restrictor configured for allowing the fluid to exit the body member. The apparatus is capable of controlling the flow rate of a liquid additive using the microporous flow restrictor.

U.S. Pat. No. 6,923,384 describes an apparatus dispensing a liquid additive into shower water by gravity feed alone. The apparatus uses a hanging additive reservoir with a valve to independently dispense a liquid additive. The additive reservoir is hung by a support, which can be mounted to a shower structure, a wall, or a curtain rod.

U.S. Pat. No. 5,274,858 shows a shower soap assembly is provided for mounting to a shower head fixture. The assembly has open opposite ends and soap holding screens mounted within for holding a cake of soap. When soap is desired, the housing is moved to a down soap loaded position such that water from the shower head nozzle passes through the housing dissolving the soap, and soapy water is dispensed through the output end. When soap is no longer desired, the housing is moved to an upright position out of the path of the stream of water.

What the prior art fails to show is any means whereby an apparatus for adding additives is an independent structure that can be easily attached or used and at the same time is workable with any water-soluble substance e.g. non-liquid additives.

### BRIEF SUMMARY OF THE INVENTION

The illustrated embodiments of the present invention include an apparatus to add non-liquid additives to the water stream exiting from a showerhead, which is separate from a showerhead and whose installation is easy, not time-consuming and inexpensive.

The illustrated embodiments include a device for adding an additive to a shower stream that exit from a showerhead by dissolving any water-soluble substances, especially non-liquid additives (e.g. tea, herbal mix, aromatic compounds), using a perforated container, which is capable of being positioned into at least a portion of the shower stream. When the container stores an additive and is positioned into at least a portion of the shower stream, a part of the shower stream flows through and/or into the container so that an additive is infused with the water. Additive infused water is then dispensed from the container by gravity feed or entrainment into the shower stream.

As shown in the illustrated embodiments, a device for adding an additive to a shower stream is attached indirectly or directly to the showerhead with an elongated arm, which holds a container in a fixed position relative the showerhead or shower stream. The device is not integrated into the showerhead and does not require retrofitting or replumbing the showerhead in any way. The elongated arm enables the device to be realized as a relatively simple structure, so that it can be manufactured with low cost.

The illustrated embodiments of the device include a fitting affixed to the elongated arm to provide a fixed position of the elongated arm relative to the showerhead to define a relative position of the container to the shower stream. The fitting may be configured to be mounted to a shower supply pipe (e.g. a pipe clip). It allows the device to be installed or removed simply and easily without the need for special tools or skills.

The illustrated embodiments also include a device for adding an additive to a shower stream that exit from a showerhead using a perforated container and a funnel which covers the both showerhead and the container. When the funnel covers the both showerhead and the container, container is positioned into the shower stream. Through the funnel from the showerhead, the container is supplied with water under pressure so that additive is infused with the water. Then, additive infused water is dispensed from the container as a re-emitted shower stream of additive infused water under pressure from the shower supply.

These and other aspects of the illustrated embodiments of the invention will now be described by way of example with reference to the detailed disclosure and the accompanying figures.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 shows a preferred embodiment of a device for adding a non-liquid additive to a shower stream with a perforated container, elongated arm, and fitting.

FIG. 1B shows the embodiment in FIG. 1 with a ring mounted on the perforated container.

FIG. 1C is a perpendicular cross sectional view of FIG. 1B showing the structure of one embodiment of the mount for fixing the apparatus to the shower pipe.

FIG. 2 shows another embodiment of a device for adding a non-liquid additive to a shower stream with a perforated container and funnel.

FIG. 3 shows an exemplary flow diagram of steps taken to add a non-liquid additive to a shower stream using a device for adding a non-liquid additive to a shower stream with a perforated container, elongated arm, and fitting

FIG. 4 shows an exemplary flow diagram of steps taken to add a non-liquid additive to a shower stream using a device for adding a non-liquid additive to a shower stream with a perforated container, and funnel.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

The following description is merely example in nature and is not intended to limit the present disclosure, application, or uses. It should be understood that throughout the drawings, corresponding reference numerals indicate like or corresponding parts and features.

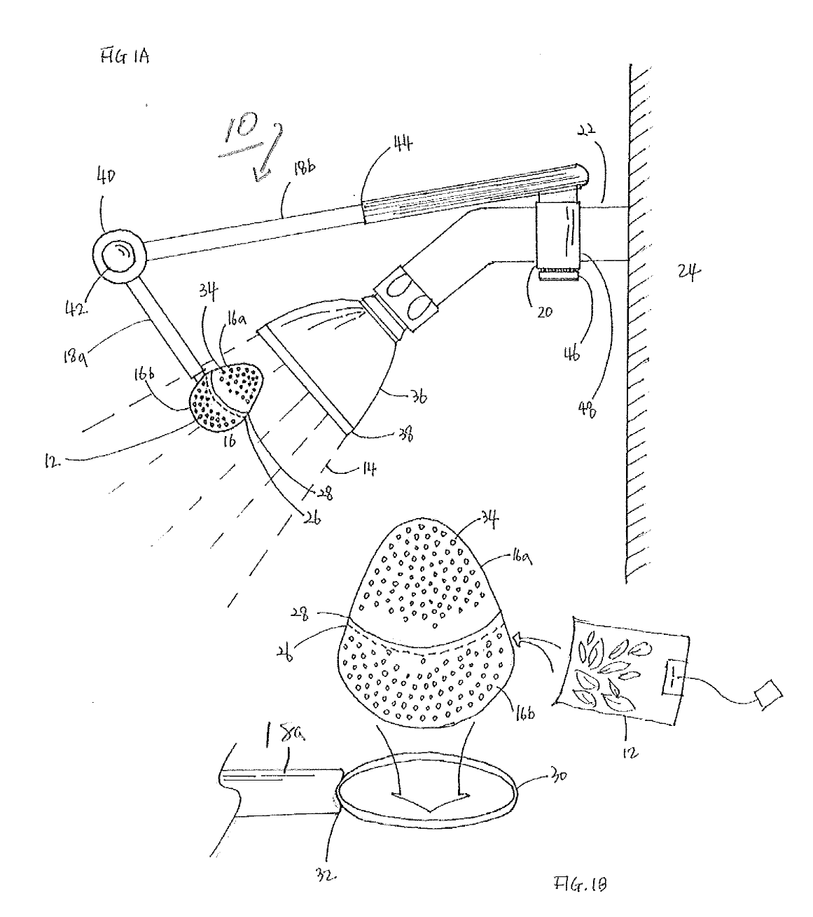

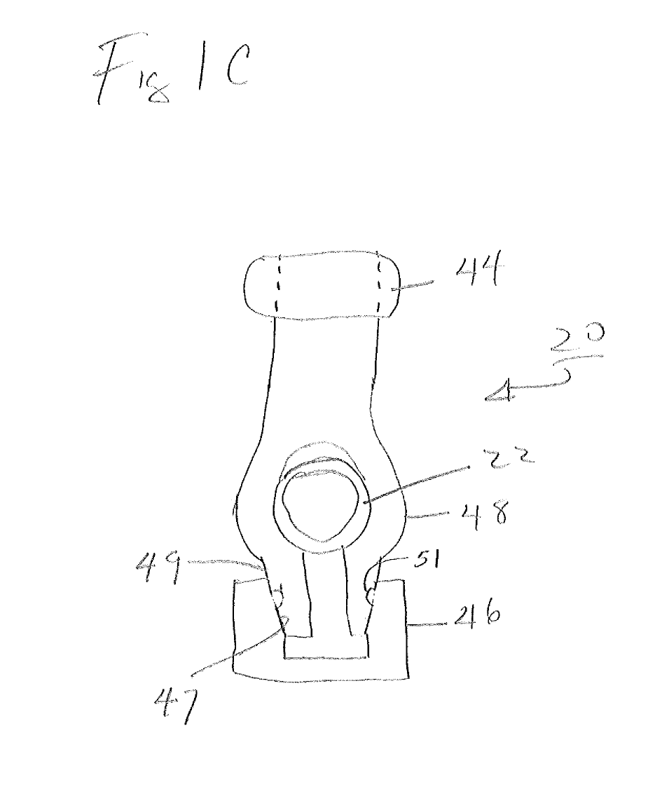

A preferred embodiment of the invention is shown in FIG. 1A. The device 10 for adding a non-liquid additive 12 to a shower stream 14 comprises three main components, which is a perforated container 16, an elongated arm 18, and a fitting 20. The fitting 20 is configured for mounting the elongated arm 18 to a shower structure, such as a shower supply pipe 22, or a wall 24.

The perforated container 16 may be in a shape of rectangle, sphere, semi-sphere, or in an egg-shape. In the embodiment shown in FIG. 1A, the perforated container 16 is in an egg-shape container. The perforated container 16 may be comprised of an upper half portion 16a and a lower half portion 16b. The top 26 of the lower half portion 16b is circumferentially recessed to define an edge 28, which may be threaded. Thus, the top portion 16a is removably attached to the edge 28 to form the egg-shape perforated container 16.

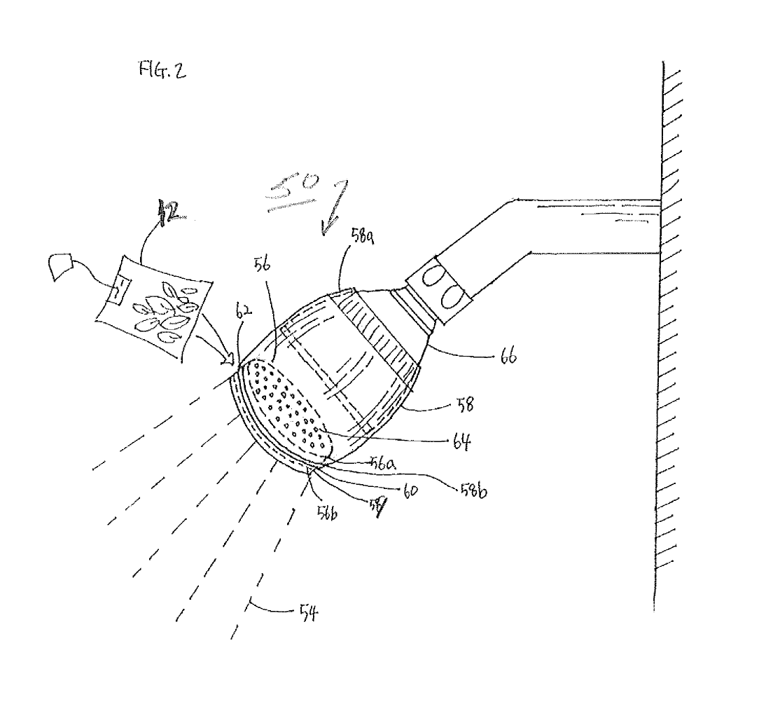

As illustrated in FIG. 1B, the ring 30 may be mounted on the container 16 to removably attach the container to the elongated arm 18. The one side 32 of the outer part of the ring 30 is affixed to the elongated arm to position the container 16 to at least a portion of the shower stream 14. The ring 30 is in a shape to fit the container in its the inner part. In an embodiment in FIG. 2, the ring 30 is in a circle shape to fit the egg-shape container 16. The ring is made of a suitable plastic, such as, but not limited to, polypropylene or a suitable metal, such as, but not limited to, stainless steel. The ring 30 may be in a variety of sizes to fit the container 16 in various sizes.

As illustrated in FIG. 1A, the top and bottom portions 16a, 16b of the container 16 are perforated with holes 34 in of which diameter is preferably less than 50 mm. The holes 34 may be or may not be defined in the entirety of the top and bottom portions 16a, 16b of the container 16. The top and bottom portions 16a, 16b of the perforated container 16 are made of a suitable plastic, such as, but not limited to, polypropylene, suitable wood, such as, but not limited to thin veneer, or a suitable metal, such as, but not limited to, stainless steel. The perforated container 16 may be in a variety of sizes to store, infuse, and dispense the non-liquid additive 12. However, the diameter or the longest edge 30 of container 16 will not be greater than the diameter of a showerhead 36 in order to minimize the blockage or interference with the shower stream 24. For this purpose, it is desirable that the diameter or the longest edge of the container 16 is no larger than approximately 5 inches.

The elongated arm 18 is in a linear shape with a curve affixed to the container 16. In the embodiment shown in FIG. 1A, the elongated arm 18 is similar to a letter “L” shape, of which the upper part is positioned above a showerhead 36 and the lower part is approximately parallel to the surface of a showerhead's outlet 38. At the curved point of the elongated arm 18, there may be a hinge joint 40 allowing the upper part and lower portions 18a, 18b respectively of the elongated arm 18 to be rotatable. The hinge joint 40 may have a pin 42 to lock both portions 18a and 18b of the elongated arm 18 with respect to each other in at least one position as described in the embodiment of FIG. 1A. For the device 10 to work with showerheads 36 in various sizes and shapes, the elongated arm 18 may be constituted with telescopic section 44 to adjust its length. The material of the elongated arm 18 is preferably a flexible material or suitable plastic, such as but not limited to polypropylene or polyethylene.

The fitting 20 is a means of coupling that may be attached by a mount to the shower structure, such as a shower supply pipe 22, the shower wall 24 or any other suitable fixed structural element to provide a fixed position of the elongated arm 18 relative to the showerhead 36 to define a relative position of the container 16 to the shower stream 14. As illustrated in the perpendicular cross sectional view of FIG. 1C, the fitting 20 may include a resilient mount 48 that expands on its lower portion to grasp or snap over shower pipe 22 and then be secured thereto by manually forcing a C-clip 46 having a V-shaped channel 47 defined therein into which a mating V-shaped pair of descending prongs 49 fits, which prongs 49 integrally extending from the lower portion of mount 48. A detent ridge 51 is defined either in prongs 49 or channel 47 to snap into a mating detent groove defined in the opposing one of prongs 49 or channel 47 to secure C-clip 46 to mount 48 when C-clip 46 has been properly positioned to tightly compress the portion of mount 48 onto pipe 22. The upper portion of mount 48 is swivel mounted to telescopic section 44 of arm 18b.

In another embodiment, the fitting 20 may be a suction cup that can be attached to a wall 24 from which shower structure extends. The fitting 20 is made of a suitable plastic, such as, but not limited to, polypropylene or a suitable metal, such as, but not limited to, stainless steel.

An embodiment of the invention is also shown in FIG. 2. The device 50 for adding a non-liquid additive 52 to a shower stream 54 comprises two main components, which is a perforated container 56, and a funnel 58.

In the embodiment shown in FIG. 2, the perforated container 56 is in cylinder-shape. The perforated container 56 may be in a shape of rectangle, sphere, semi-sphere, or in any shape that works with the funnel 58. The perforated container 56 may be comprised of an upper half portion 56a and a lower half portion 56b. The top 58 of the lower half portion 56b is circumferentially recessed to define an edge 60, which may be threaded so that the top portion 56a is removably attached to the edge 60 to form the cylinder-shape perforated container 56. And a ring 62 is mounted on the top of the upper half portion 56b to connect the container 56 with the lower part 58b of the funnel 58. Thus, after the lower half portion of container 56b stores the additive 52, it could be attached to the upper half portion 56a and, thereby, the container 56 is attached to the lower part of the funnel 58b to be positioned in at least a portion of the shower stream 54.

As described in FIG. 2, the top and bottom portions 56a, 56b of the container 56 are perforated with holes 64 in of which diameter is preferably less than 50 mm. The holes 64 may be or may not be defined in the entirety of the top and bottom portions 56a, 56b of the container 56. The top and bottom portions 56a, 56b of the perforated container 56 are made of a suitable plastic, such as, but not limited to, polypropylene or a suitable metal, such as, but not limited to, stainless steel. The perforated container 56 may be in a variety of sizes to store, infuse, and dispense the non-liquid additive 52.

The funnel 58 is a sleeve connecting the container 56 and the showerhead 66 to provide a relative position of the container 56 to the shower stream 54. As illustrated in FIG. 2. The lower edge 58b of the funnel 58 is removably locked up to ring 62 mounted on the container 56. And the upper edge 58a of the funnel 58 covers nearly more than half surface of the showerhead 66. The funnel 58 is made of suitable elastic material such as, but not limited to, rubber. To supply the container 56 with water under pressure and to dispense additive infused water as a re-emitted shower stream under pressure, it is desirable that the length of the funnel is as such to make the distance between the showerhead 66 and the container 56 less then 3 inches.

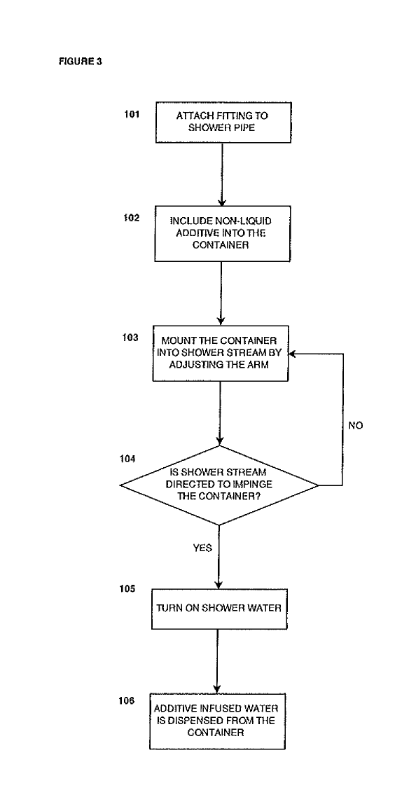

FIG. 3 depicts an exemplary flow diagram of the steps taken to add a non-liquid additive 12 to a shower stream 14 using a device 10 for adding a non-liquid additive 12 to a shower stream 14 with a perforated container 16, elongated arm 18, and fitting 20. A user attaches a fitting 20 to a suitable shower structure, such as a shower pipe 22 (step 101). After including a non-liquid additive 12 into the perforated container 16 (step 102), the user mounts the perforated container 16 into a position at least in part to be disposed in the shower stream 14 by adjusting the elongated arm 18 with hinge joint 40 (step 103). If the shower stream 14 is directed to impinge at least in part onto the perforated container 16 by arranging the relative position of the perforated container 16 and shower stream 14 (step 104), then turn on the shower water supply (step 105). If the shower stream 14 is not directed to impinge at least in part onto the perforated container 16, the user adjusts the elongated arm 18 to mount the perforated container 16 into the shower stream 14 (step 103). When shower water is supplied, additive infused water is dispensed from the container 16 by gravity feed or entrainment into the shower stream (step 106).

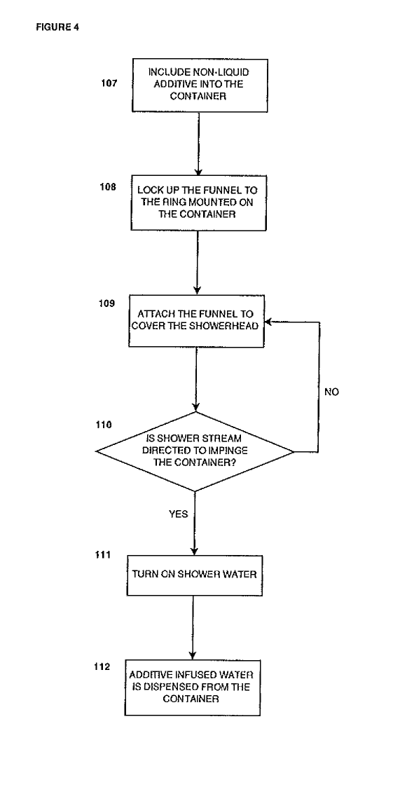

FIG. 4 depicts an exemplary flow diagram of the steps taken to add a non-liquid additive 52 to a shower stream 54 using a device 50 for adding a non-liquid additive 52 to a shower stream 54 with a perforated container 56 and funnel 58. A user includes a non-liquid additive 52 into the perforated container 56 (step 107). After locking up the funnel 58 to the ring 62 mounted on the perforated container 56 (step 108), the funnel 58 is attached to the showerhead 66 covering more than half portion of it to position the perforated container 56 into the shower stream 54 (step 109). If the shower stream 54 is directed to impinge onto the perforated container 56 by arranging the relative position of the perforated container 56 and shower stream 54 (step 110), turn on the shower water supply (step 111). If the shower stream 54 is not directed to impinge onto the perforated container 56, the user re-attaches the funnel 58 to the showerhead 66 (step 109). When shower water is supplied, additive infused water is dispensed from the container 56 as a re-emitted shower stream of additive infused water under pressure from the shower (step 112).

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. A device adding a non-liquid additive to a shower stream exiting from a showerhead comprising:
a perforated container in which the non-liquid additive is included, the perforated container capable of being positioned into at least a portion of the shower stream;
an elongated arm having a first end and a second end, wherein the first end is attached to the container; and
a fitting affixed to the second end of the elongated arm to provide a fixed position of the elongated arm relative to the showerhead to define a relative position of the container to the shower stream,
whereby the perforated container stores, infuses and dispenses additive into the shower stream.

2. The device of claim 1 wherein the perforated container further includes a liquid additive disposed therein.

3. The device of claim 1, where the perforated container is comprised of an upper portion and a lower portion, where the upper portion is removably coupled to the lower portion.

4. The device of claim 1, where a ring is mounted on the perforated container and the ring is affixed to the elongated arm to removably attach the perforated container.

5. The device of claim 1, where the elongated arm comprises a upper arm, a lower arm and a hinge joint coupling the upper arm and lower arm together and allowing rotation of the upper and lower arms relative to each other.

6. The device of claim 3, where the hinge joint is lockable into a selected relative position of the upper and lower arms with respect to each other.

7. The device of claim 1, where the elongated arm comprises a telescopic pole.

8. The device of claim 1 where the perforated container has a rectangular, spheral, semi-spherical, or an egg-shape.

9. The device of claim 1 where the perforated container is sized to intercept only a portion of the shower stream, additive infused water dispensed from the perforated container into and being entrained in portions of the shower stream which are not intercepted by the container.

10. The device of claim 1 where the perforated container is sized to intercept substantially all of the shower stream, additive infused water dispensed from the perforated container as a re-emitted shower stream of additive infused water.

11. A device for adding a non-liquid additive to a shower stream exiting a showerhead comprising:
a perforated container in which the non-liquid additive is included, the container capable of being positioned into at least a portion of the shower stream and having a top section; and
a funnel made of elastic material having an upper and lower part, where the lower part of the funnel is removably attached to the top section of the container, and the upper part of funnel is removably attached to the showerhead,
whereby the container stores, infuses and dispenses additives into a shower stream.

12. The device of claim 10 where the perforated container is supplied water under pressure through the funnel from the showerhead, additive infused water being dispensed from the perforated container as a re-emitted shower stream of additive infused water under pressure.

13. A method for adding a non-liquid additive to a shower stream exiting from a showerhead comprising:
providing a perforated container in which the non-liquid additive is included, an elongated arm having a first end and a second end, wherein the first end is attached to the container; and a fitting affixed to the second end of the elongated arm to provide a fixed position of the elongated arm relative to the showerhead to define a relative position of the container to the shower stream;
mounting the perforated container into a position at least in part to be disposed in the shower stream using the elongated arm and fitting;
directing the shower stream to impinge at least in part onto the perforated container by arranging the relative position of the perforated container and shower stream,
whereby the perforated container stores, infuses and dispenses the non-liquid additive into the shower stream.

14. The method of claim 12, where providing the elongated arm comprises providing an upper portion and a lower portion of the elongated arm, where the upper portion is removably coupled to the lower portion and providing a hinge joint coupling the upper arm and lower arm together and further comprising rotating the upper and lower arms relative to each other to position the perforated container at least in part to be disposed in the shower stream.

15. The method of claim 13 further comprising locking the hinge joint into a selected relative position of the upper and lower arms with respect to each other.

16. The method of claim 12 where the perforated container is sized to intercept only a portion of the shower stream, further comprising dispensing additive infused water from the perforated container into and entraining additive infused water in portions of the shower stream which are not intercepted by the container.

17. The method of claim 12 where the perforated container is sized to intercept substantially all of the shower stream, and further comprising dispensing additive infused water from the perforated container as a re-emitted shower stream of additive infused water under pressure.

18. The method of claim 16 further comprising supplying the perforated container with water under pressure through a funnel coupled to the showerhead.
